(19) United States
(12) Patent Application Publication
(10) Pub. No.: US 2016/0366087 A1
(43) Pub. Date: Dec. 15, 2016

(54) MAIL SERVER

(71) Applicant: Sharp Kabushiki Kaisha, Osaka (JP)

(72) Inventor: Toshiyuki TANIUCHI, Osaka (JP)

(73) Assignee: Sharp Kabushiki Kaisha, Osaka (JP)

(21) Appl. No.: 15/248,776

(22) Filed: Aug. 26, 2016

Related U.S. Application Data
(63) Continuation of application No. 13/225,849, filed on Sep. 6, 2011, now abandoned.

(30) Foreign Application Priority Data
Sep. 7, 2010 (JP) 2010-199502

(51) Int. Cl. H04L 12/58

(52) U.S. Cl. CPC H04L 51/28; H04L 51/22; H04L 51/02

(57) ABSTRACT

A mail server includes an address information table in which address information is registered including ability or inability to use each mail address, and a notify party information table in which notify party information is registered specifying each notify party to notify that a mail address cannot be used. The mail server further includes a control section, which carries out a first process to judge, referring to the address information table, whether a mail address of a destination of a received mail is available or not; a second process to judge, referring to the notify party information table, whether the mail address of the source of the received mail falls within the notify party information; a third process to create a reply mail stating that the mail address of the destination cannot be used; and a fourth process to transmit the reply mail to the mail address of the source.

### CROSS REFERENCE

This application is a Continuation of co-pending application Ser. No. 13/225,849, filed on Sep. 6, 2011, and for which priority is claimed under 35 U.S.C. §120. Application Ser. No. 13/225,849 claims priority under 35 U.S.C. §119(a) on Patent Application No. 2010-199502 filed in Japan on Sep. 7, 2010, the entire contents of which are hereby incorporated by reference.

### BACKGROUND OF THE INVENTION

The present invention relates to a mail server that administers transmission and reception of emails.

A mail server administers at least one domain, and has a is mail box for each mail address that has a domain it administers. Upon receiving an email (hereinafter, referred to as “mail”), the mail server, referring to header information of the mail, acquires a mail address of a destination of the mail. When a domain of the mail address of the destination accords with any domain the apparatus of its own administers, the mail server temporarily stores the received mail in a mail box for the mail address of the destination. The temporarily stored mail is downloaded by a user to a client apparatus, and is then referred to.

Also, when a change of a mail address is made by a user, the mail server sets the mail address before the change (i.e., mail address from which the change has been made) being unable to be used (i.e., unavailable), while setting a mail address after the change (i.e., mail address to which the change has been made) being able to be used (i.e., available). In a case where the change includes a change of a domain, a mail server that administers the domain after the change (i.e., domain to which the change has been made) sets, based on the direction of the user, the mail address after the change being available.

The mail server, on receiving a mail to a mail address before the change after the change of the mail address has been made, returns an error-informing mail to a source of the mail (i.e., the mail sender). The error-informing mail enables the mail server to notify the source of the mail that the mail address before the change cannot be used; however, this alone does not allow the mail server to notify the source of the mail of the mail address after the change. As a result, it is necessary for a user who has changed its mail address to send to many specific users notice to the effect that its mail address has been changed. Such notice is a procedure that is troublesome for the user.

To eliminate such a troublesome procedure, among the conventional mail server is one that notifies, on receiving a mail to a mail address before the change, the source of the mail of the mail address after the change (refer to Japanese Patent Unexamined Publication No. 2001-111601 bulletin). The mail server includes a transfer information database, and registers therein a mail address after the change associating thereof with a mail address before the change at the time of the change of the mail address.

The mail server as described in the Japanese Patent Unexamined Publication No. 2001-111601 bulletin, however, on receiving a mail to the mail address before the change, notifies any source of such mail equally of a mail address after the change. Consequently, the mail server may send notice of the mail address after the change even to a source of the mail to which it is not necessary to do so; so that it cannot protect personal information.

Then, the present invention is directed to providing a mail server capable of sending notice to the effect that the mail address has been changed only to sources of mails to which it is deemed necessary to do so based on the user's decision.

### SUMMARY OF THE INVENTION

A mail server of the present invention administers at least one domain, and comprises a mail box for storing per mail address mails to a mail address that has any said domain (hereinafter, simply referred to as “the domain”), a memory means, an acquisition means and a control means. The mail server may further comprise an address information updating means, and a notify party information updating means.

The memory means stores an address information table in which address information is registered that includes ability or inability to use each mail address that has the domain, and a notify party information table in which notify party information is registered that specifies one or more notify parties that are to be notified that a mail address having the domain cannot be used. The address information updating means accepts addition, change and/or deletion of a mail address having the domain, and thereby updates the address information table. The notify party information updating means accepts addition and/or deletion of a piece of the notify party information, and thereby updates the notify party information table. The acquisition means acquires a mail address of a source of a received mail along with a mail address of its destination.

The control means controls a first through a fourth processes. In the first process, the control means judges, referring to the address information table, ability or inability to use the mail address of the destination. In the second process, the control means judges, referring to the notify party information table, whether the mail address of the source of the mail falls within the notify party information. In the third process, the control means creates a reply mail stating that the mail address of the destination cannot be used. In the fourth process, the control means transmits the reply mail to the mail address of the source of the mail. The control means creates the reply mail in the third process in a case where it is judged in the first process that the mail address of the destination is unable to be used (i.e. unavailable) and where it is judged in the second process that the mail address of the source of the mail falls within the notify party information.

With this configuration, the address information updating means accepts addition, updating and/or deletion of a piece of the address information, and stores the address information in the address information table beforehand; and the notify party information updating means accepts addition and/or deletion of a piece of the notify party information, and stores the notify party information in the notify party information table beforehand. The acquisition means, on receiving a mail, acquires an address of the source of the mail and an address of the destination of the mail. The control means, referring to the address information table in the first process, judges ability or inability to use the mail address of the destination; and then referring to the notify party information table in the second process, judges whether the mail address of the source of the mail falls within the notify party information. The control means creates, in the third process, the reply mail stating that the mail address of the destination cannot be used, in the case where it is judged in the first process that the mail address of the destination is unavailable and where it is judged in the second process that the mail address of the source of the mail falls within the notify party information. The control means transmits, in the fourth process, the reply mail created in the third process to the mail address of the source of the mail.

Preferably, the address information updating means is configured such that upon accepting a change from a mail address having the domain to a new mail address, it associates the new mail address with the mail address having the domain, and such that it renders the mail address having the domain unavailable. In this case, the control means, referring to the address information table in the third process, makes, in the reply mail, a statement of the new mail address associated with the mail address of the destination.

With this configuration, the address information updating means, on accepting the change to the new mail address, associates the new mail address with the mail address before the change, and then renders the mail address before the change unavailable. The control means creates, in the third process, the reply mail that states the mail address after the change. As a consequence, the mail server is, on receiving a mail to a mail address before the change, capable of sending notice of a mail address after the change only to a necessary source of the mail.

Preferably, the notify party information is on domain. In this case, the control means, referring to the notify party information table in the third process, creates the reply mail when a domain of the mail address of the source of the mail is registered in the notify party information table. With this configuration, the control means creates the reply mail when the domain of the mail address of the source of the mail is registered in the notify party information table. As a consequence, the mail server is capable of making a decision as to whether to create the reply mail in units of domain or not.

Preferably, the notify party information is on mail address. In this case, the control means, referring to the notify party information table in the third process, creates the reply mail when a mail address of the source of the mail is registered in the notify party information table. With this configuration, the control means creates the reply mail when the mail address of the source of the mail is registered in the notify party information table. As a consequence, the mail server is capable of making a decision as to whether to create the reply mail in units of mail address or not.

### BRIEF DESCRIPTION OF THE DRAWINGS

FIG. 1 is a block diagram showing a functional configuration of a mail server according to an embodiment of the present invention.

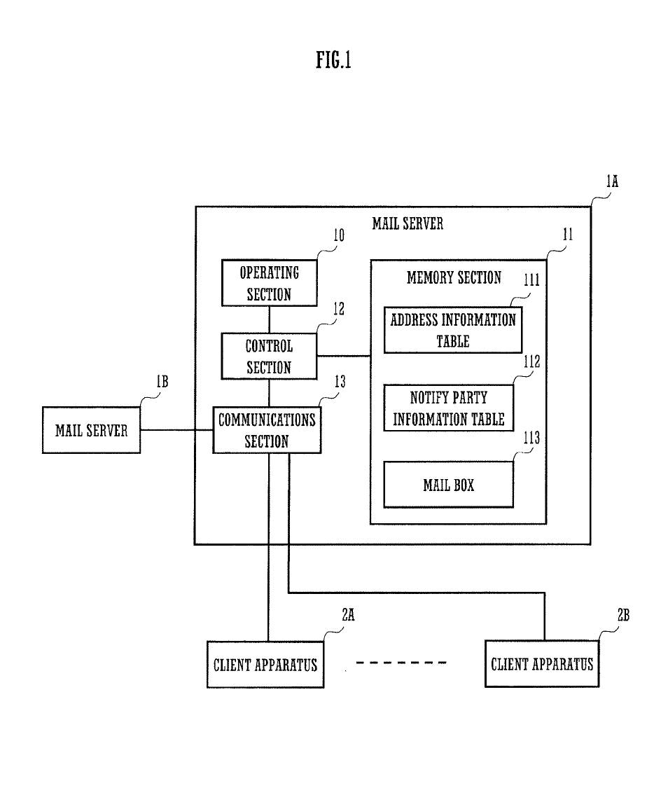

FIG. 2 is a diagram showing an example of an address information table.

FIG. 3A and FIG. 3B are diagrams each showing an example of a notify party information table.

FIG. 4 is a flowchart showing an address information updating operation and a notify party information updating operation by a control section.

FIG. 5 is a flowchart showing a mail reception process by the control section.

### DETAILED DESCRIPTION OF THE INVENTION

A mail server according to an embodiment of the present invention is explained below, referring to the drawings.

First of all, it is assumed that a mail server 1A is connected to a mail server 1B and client apparatus 2A, 2B through a network. Also, the numbers of the mail server 1B and the client apparatus 2A, 2B that are connected to the mail server 1A are not limited to one and two, respectively. Further, the mail server 1A carries out transmission and reception of mails to and from the mail server 1B either directly or via a DNS server (not shown).

The mail server 1A includes an operating section 10, a memory section 11, a control section 12 and a communications section 13, and administers a domain (ABC.COM). The mail server 1A receives mails to mail addresses (hereinafter, referred to as “address(es)”) having the domain (ABC.COM).

The operating section 10 accepts operations for addition, change and/or deletion of an address, along with operations for addition and/or deletion of a piece of notify party information, and/or the like.

The memory section 11 stores an address information table 111, a notify party information table 112 and a mail box 113.

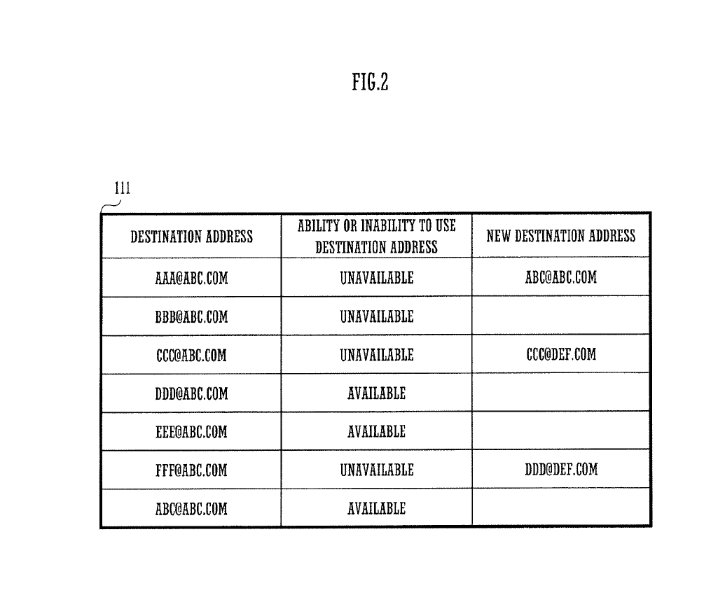

The address information table 111, as shown in FIG. 2 as an example, stores destination addresses, ability or inability to use the destination addresses and new destination addresses, each of the categories being associated with others. A destination address is an address having the domain (ABC.COM). Among the destination addresses are ones currently able to be used (i.e., available) and the others currently unable to be used (i.e., unavailable). ‘Ability or inability to use’ status of a destination address indicates whether the destination address is currently available or unavailable. A new destination address is an address after a change that has become newly available by the change of a destination address. A domain of a new destination address is not limited to one having the domain (ABC.COM).

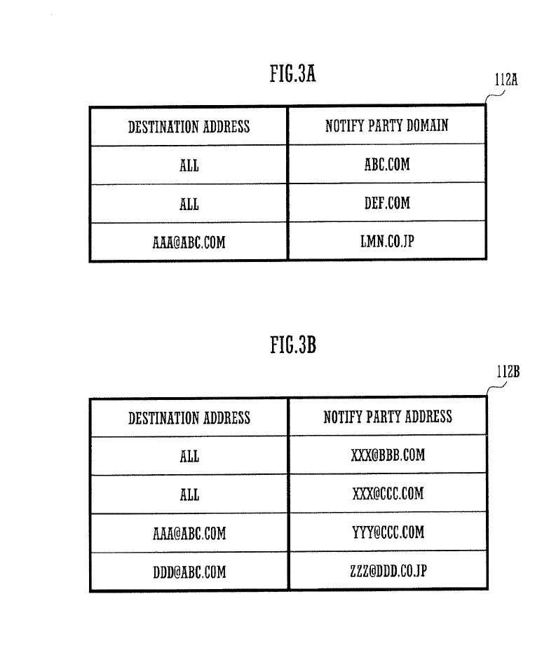

The notify party information table 112, as shown in FIG. 3A and FIG. 3B each as an example, respectively stores, for each destination address, a notify party domain 112A and a notify party address 112B, both of which are for parties to which a reply mail stating that the destination address cannot be used is to be sent. The destination address indicated by ALL means all the destination addresses that are unavailable among those registered in the address information table 111. In this manner, registered in the notify party information table 112 are notify parties to all of which addresses that have become unavailable the reply mail is to be sent, along with notify parties to each of which address that has become unavailable the reply mail is to be sent.

The mail box 113 is provided per every available address, and mails to each address are saved by the control section 12. The mails stored in the mail box 113 are downloaded to the client apparatus 2A and 2B by users, and then they are referred to. The mails are erased from the mail box 113 when they are downloaded to the client apparatus 2A and 2B, or after the passage of a predetermined period (such as a week or a month) after they have been saved in the mail box 113.

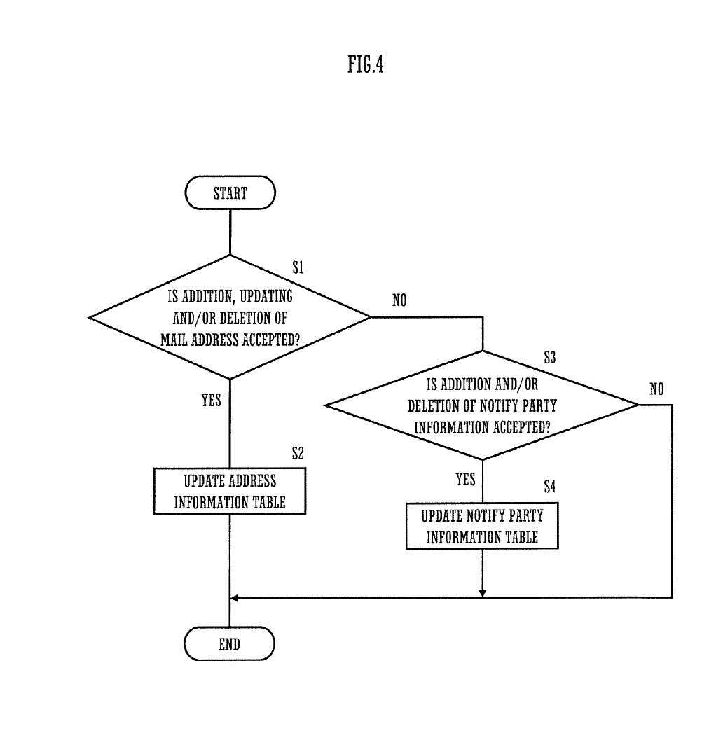

The control section 12 updates the address information table 111 and the notify party information table 112 depending on an operational input from the operating section 10. To be concrete, as shown in FIG. 4, when the operating section 10 accepts an addition of an address (ABC@ABC.COM) (S1: YES), the control section 12 adds it to the destination address (ABC@ABC.COM) of the is address information table 111, renders the added destination address available (S2), and then completes a process. When the operating section 10 accepts a change from an address (FFF@ABC.COM) to an address (DDD@DEF.COM) (S1: YES), the control section 12 renders the destination address (FFF@ABC.COM) of the address information table 111 unavailable, adds the new destination address (DDD@DEF.COM) associating it with the former destination address (FFF@ABC.COM) (S2), and then completes a process. When the operating section 10 accepts a deletion of an address (EEE@ABC.COM) (S1: YES), the control section 12 renders the destination address (EEE@ABC.COM) of the address information table 111 (S2) unavailable, and completes a process.

Further, when the operating section 10 accepts additions of the destination address (ALL) that is unavailable and a domain (ABC.COM) that is a piece of the notify party information (S1: NO→S3: YES), the control section 12 adds them to the notify party information table 112, associating the notify party domain (ABC.COM) 112A with the destination address (ALL) (S4), and completes a process. When the operating section 10 accepts a deletion of a destination address (BBB@ABC.COM) and a mail address (YYY@CCC.COM) (S1: NO→S3: YES), the control section 12 deletes the destination address (BBB@ABC.COM) and the notify party address (YYY@CCC.COM) 112B associated with the destination address (BBB@ABC.COM) from the notify party information table 112 (S4), and completes a process. FIG. 3A shows a state of the notify is party information table 112 after the destination address (ALL) has been added to it being associated with the notify party domain (ABC.COM) 112A; and FIG. 3B shows a state of the notify party information table 112 after the destination address (BBB@ABC.COM) and the notify party address (YYY@CCC.COM) 112B associated with the destination address (BBB@ABC.COM) have been deleted from it.

The communications section 13, based on the direction from the control section 12, carries out transmission and reception of mails to and from the mail server 1B and the client apparatus 2A, 2B.

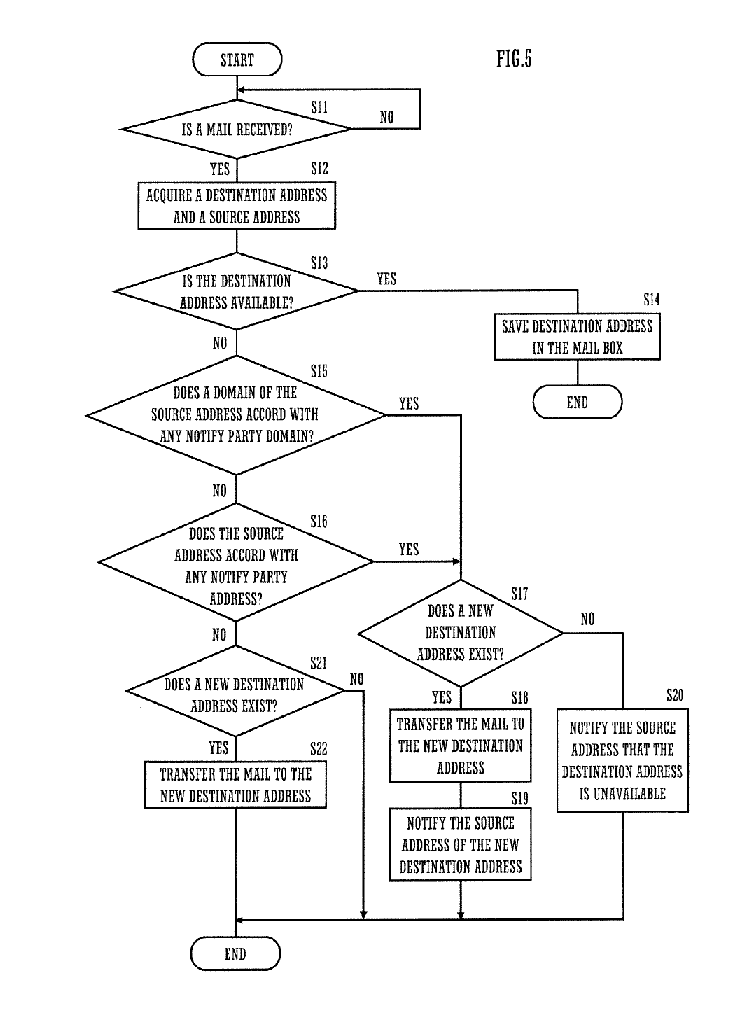

Subsequently, a process flow of the control section 12 at the time of mail reception is explained referring to FIG. 5. Explained below as an exemplification is a case where the mail server 1A has received a mail to a destination address (AAA@ABC.COM) from a source address (DDD@ABC.COM).

As shown in FIG. 5, the control section 12, waiting until the communications section 13 receives a mail (S11: NO) and on receiving a mail (S11: YES), acquires the destination address (AAA@ABC.COM) and the source address (DDD@ABC.COM) from the header information of the mail (S12).

The control section 12, referring to the address information table 111, saves the mail in the mail box 113 for the destination address (S14) if the destination address (AAA@ABC.COM) is available (S13: YES), and then completes a task.

However, since the destination address (AAA@ABC.COM) is unavailable (S13: NO), the control section 12, referring to the notify party information table 112, checks the domain first. That is, the control section 12 judges whether the domain (ABC.COM) of the source address (DDD@ABC.COM) accords with any notify party domain 112A (S15) or not. In other words, the control section 12 judges whether the domain (ABC.COM) accords with any notify party domain 112A associated with the destination address (ALL or AAA@ABC.COM).

Since the domain (ABC.COM) of the source address accords with a notify party domain 112A (S15: YES), the control section 12, referring to the address information table 111, judges whether there is any new destination address associated with the destination address (AAA@ABC.COM) (S17).

Since the new destination address (ABC@ABC.COM) is associated with the destination address (AAA@ABC.COM) (S17: YES), the control section 12 transfers the mail to the new destination address (ABC@ABC.COM) (S18). To be concrete, since the apparatus of its own administers the domain (ABC.COM) of the new destination address (ABC@ABC.COM), the control section 12 saves the received mail in a mail box for the new destination address (ABC@ABC.COM), to causing the source address (DDD@ABC.COM) and the destination address (ABC@ABC.COM) to be a piece of header information. Or, the control section 12 may, without changing the destination address, save the received mail as it is in the mail box for the new destination address (ABC@ABC.COM). Whereas in a case where the apparatus of its own does not administer the domain (ABC.COM) of the new destination address (ABC@ABC.COM), the control section 12 transmits the mail to another mail server administering the domain (ABC.COM) of the new destination address (ABC@ABC.COM), causing the source address (DDD@ABC.COM) and the destination address (ABC@ABC.COM) to be a piece of header information.

The control section 12 creates a reply mail stating the new destination address (ABC@ABC.COM), transmits it to the source address (DDD@ABC.COM) (S19), and completes a task. The reply mail has a piece of header information including the source address (AAA@ABC.COM) and the destination address (DDD@ABC.COM).

In a case where there is no new destination address associated with the destination address (S17: NO), the control section 12 creates a reply mail stating that the destination address (AAA@ABC.COM) cannot be used, transmits it to the source address (DDD@ABC.COM) (S20), and completes a task. The reply mail has a piece of header information including the source address (AAA@ABC.COM) and the destination address (DDD@ABC.COM).

Further, in a case where a domain does not match in a domain check in step S15, or for instance, when it has received a mail to a destination address (AAA@ABC.COM) from a source address (YYY@ CCC.COM), the control section 12, since the domain (CCC.COM) of the source address (YYY@CCC.COM) does not accord with any notify party domain 112A (S15: NO), judges whether the source address (YYY@CCC.COM) accords with any notify party address 112B (S16) or is not. That is to say, the control section 12 judges whether the source address (YYY@CCC.COM) accords with any notify party address 112B associated with the destination address (ALL or AAA@ABC.COM) or not.

The control section 12, since the source address (YYY@CCC.COM) accords with a notify party address 112B (S16: YES), proceeds to S17.

Also, in a case where the source address (YYY@CCC.COM) does not accord with any notify party address 112B (S16: NO), the control section 12, referring to the address information table 111, judges whether there is a new destination address (ABC@ABC.COM) associated with the destination address (AAA@ABC.COM) (S21) or not. The control section 12, since the new destination address (ABC@ABC.COM) is associated with the destination address (AAA@ABC.COM) (S21: YES), transfers the mail to the new destination address (ABC@ABC.COM) (S22), and completes a task. To be concrete, when the apparatus of its own administers the domain (ABC.COM) of the new destination address (ABC@ABC.COM), the control section 12 may save the received mail as it is in the mail box for the new destination address (ABC@ABC.COM), causing the source address (YYY@CCC.COM) and the destination address (ABC@ABC.COM) to be a piece of header information. Or, the control section 12 may, without changing the header information, save the received mail as it is in the mail box for the new destination address (ABC@ABC.COM). In a case where the apparatus of its own does not administer the domain (ABC.COM) of the new destination address (ABC@ABC.COM), the control section 12 transmits the mail to another mail server administering the domain (ABC.COM) of the new destination address (ABC@ABC.COM), causing the source address (DDD@ABC.COM) and the destination address (ABC@ABC.COM) to be a piece of header information.

In a case where a new destination address is not associated with the destination address (AAA@ABC.COM) (S21: NO), the control section 12 just finish a task.

As described above, it is only when a source address of a mail is registered beforehand in the notify party information table 112 as a notify party domain 112A or as a notify party address 112B that the control section 12 transmits to the source address a reply mail stating that the destination address cannot be used any more along with an indication of the new destination address. This enables the control section 12 to notify only necessary source(s) that the destination address has become unavailable and of the new destination address, thereby making it possible to protect personal information.

Additionally, it has been explained in S18 and S22 of FIG. 5 that the control section 12 transfers a mail to a new destination address. However, instead of doing so, the control section 12 may transmit to the new destination address notice to the effect that the mail has reached the destination address. Further, instead of doing this, the control section 12 may transfer the mail to the new destination address in S18, and send to the new destination address notice to the effect that the mail has reached the destination address in S22. Thus, the control section 12 is capable of transferring, to a new destination address, only the mails from source addresses matching any notify party domain or any notify party address each of which is registered beforehand.

Also, it has been explained in the above described embodiment that addition, change and/or deletion of an address, and addition and/or deletion of a piece of the notify party information and/or the like are accepted by the operating section 10. However, the mail server 1A may include a WEB server facility, and may accept addition, change and/or deletion of an address, and addition and/or deletion a piece of the notify party information and/or the like from the client apparatus 2A, 2B by way of WEB.

The above explanation of the embodiment is nothing more than illustrative in any respect, nor should be thought of as restrictive. Scope of the present invention is indicated by claims rather than the above embodiment. Further, it is intended that all changes that are equivalent to a claim in the sense and realm of the doctrine of equivalence be included within the scope of the present invention.

What is claimed is:

1. A mail server administering at least one domain and provided with a mail box for storing mails to a mail address having the domain, the mail server comprising:
a memory section to store:
address information that includes:
availability or unavailability of the mail address, and
a new mail address to be used when the mail address is unavailable; and
notified party information that specifies a notified party to notify that the mail address is unavailable;
an acquisition section to acquire a mail address of a source of a received mail and a mail address of a destination of the is received mail; and
a control section to perform:
a first process to judge, referring to the address information, whether the mail address of the destination is available or not; and
a second process to judge, in a case of judging in the first process that the mail address of the destination is unavailable, whether the mail address of the source is included in the notified party information, referring to the notified party information, to determine a subsequent process.

2. The mail server according to claim 1, wherein the control section, in a case of judging in the second process that the mail address of the source is included in the notified party information, notifies the mail address of the source that the mail address of the destination is unavailable.

3. The mail server according to claim 1, wherein:
the control section further performs a third process to judge, in a case of judging in the second process that the mail address of the source is included in the notified party information, whether the new mail address is stored in the memory section; and
the control section, in a case of judging in the third process that the new mail address is not stored in the memory section, notifies the mail address of the source that the mail address of the destination is unavailable.

4. The mail server according to claim 1, wherein:
the control section further performs a third process to judge, in a case of judging in the second process that the mail address of the source is included in the notified party information, whether the new mail address is stored in the memory section; and
the control section, in a case of judging in the third process that the new mail address is stored in the memory section, sends the received mail to the new mail address.

5. The mail server according to claim 1, wherein:
the control section further performs a third process to judge, in a case of judging in the second process that the mail address of the source is included in the notified party information, whether the new mail address is stored in the memory section; and
the control section, in a case of judging in the third process that the new mail address is stored in the memory section, sends the new mail address to the mail address of the source.

6. The mail server according to claim 1, wherein:
the control section further performs a fourth process to judge, in a case of judging in the second process that the mail address of the source is not included in the notified party information, whether the new mail address is stored in the memory section; and
the control section, in a case of judging in the fourth process that the new mail address is stored in the memory section, sends the received mail to the new mail address.

7. A method for processing mails by using a mail server administering at least one domain and provided with a mail box for storing mails to a mail address having the domain, the method comprising:
storing:
address information that includes:
availability or unavailability of the mail address, and
a new mail address to be used when the mail address is unavailable; and
notified party information that specifies a notified party to notify that the mail address is unavailable;
acquiring a mail address of a source of a received mail and a mail address of a destination of the received mail; and
performing:
a first process to judge, referring to the address information, whether the mail address of the destination is available or not; and
a second process to judge, in a case of judging in the first process that the mail address of the destination is unavailable, whether the mail address of the source is included in the notified party information, referring to the notified party information, to determine a subsequent process.
